(19) United States
(12) Patent Application Publication
(10) Pub. No.: US 2018/0179372 A1
(43) Pub. Date: Jun. 28, 2018

(54) Elastomeric Compositions and Their Use in Articles

(71) Applicant: ExxonMobil Chemical Patents Inc., Baytown, TX (US)

(72) Inventor: Maria D. Ellul, Silver Lake Village, OH (US)

(21) Appl. No.: 15/736,007

(22) PCT Filed: Jul. 28, 2015
(86) PCT No.: PCT/US2015/042428

§ 371 Date: Dec. 13, 2017

(51) Int. Cl. C08L 23/22; C08J 5/18; C08J 3/00; C08J 3/20

(52) U.S. Cl. CPC C08L 23/22; C08J 5/18; C08J 3/005; C08L 2207/04; C08J 2323/22; C08J 2477/06; C08J 3/203

(57) ABSTRACT

A dynamically vulcanized alloy contains at least one isobutylene-based elastomer, at least one thermoplastic resin, a cure system, and a lubricant system. The lubricant system is comprised of a metal organic salt and a fatty acid having a phr ratio range of metal organic salt to fatty acid of 0.75:1 to 10:1. In the alloy, the elastomer is present as a dispersed phase of small vulcanized or partially vulcanized particles in a continuous phase of the thermoplastic resin. The alloy may be formed into blown films or extruded cast sheets and is useful in various applications, including tire innerliners and hose layers, where impermeability characteristics are desired for either the particular layer or the final article.

### FIELD OF THE INVENTION

The present invention relates to thermoplastic elastomeric compositions. More particularly, the present invention is directed to a thermoplastic elastomeric composition comprising compounds that act as lubricants for when forming extrusion blown or cast film from the thermoplastic elastomer composition.

### BACKGROUND OF THE INVENTION

The present invention is related to thermoplastic elastomeric compositions particularly useful for tire and other industrial rubber applications, reinforced or otherwise, that require impermeability characteristics.

Low-permeability thermoplastic elastomeric composition suitable for use in tire innerliners comprising a low permeability thermoplastic in which is dispersed a low permeability rubber have been disclosed for at least ten years. The composition is a dynamically vulcanized alloy (DVA) typically formed in an extruder wherein the rubber is dispersed as small particles into the thermoplastic and vulcanized under the dynamic conditions in the extruder. Also known are thermoplastic vulcanizates (TPVs) of rubber and thermoplastic resin wherein the rubber and resin are derived from a common monomer; i.e., TPVs of EPDM and ethylene-propylene copolymers or propylene homopolymer or ethylene homopolymer.

Preparation and compounding of TPVs from materials derived from common monomers and of comparable melt viscosities is well known; however using TPV preparation and compounding techniques for DVAs formed from materials having no common monomers and different melt viscosities has proven to include challenges in obtaining the desired phase conversion of the materials, sufficient cure state, and processability in both preparing the DVA and products formed from the DVA.

In addressing the viscosity difference between the different materials, plasticizers of different structures and differing grafting abilities have been added to the compositions. For elastomer-rich compounds, the presence of a plasticizer grafted to the thermoplastic resin works to effectively increase the amount of thermoplastic present in the alloy and enables the more dominate compound in the alloy, i.e., the elastomer, to achieve phase inversion whereby the elastomer is present in a discrete phase within a continuous phase of thermoplastic resin. Cure systems and methods of manufacturing have also been investigated and adjusted to enable any early and/or delayed grafting of the various DVA components in the extruder.

Current DVA compositions suitable for use as low permeability, highly flexible sheets/films have proven to meet the desired phase inversion, cure, and processing during formation in an extruder. However, favorable processing of the obtained DVA material into a cast or extruder article is also based on the composition of the DVA. While compounds/ingredients may be added to the DVA composition to improve post-formation article processing, these added ingredients will impact both the DVA formation processing and article performance characteristics. The present invention is directed to thermoplastic elastomeric compositions prepared by dynamic vulcanization wherein the obtained DVA exhibits desirable formation processing properties, the needed composition structure, and improved post-formation processing without significantly compromising or minimally affecting any desired cure or phase inversion.

### SUMMARY OF THE INVENTION

The present invention is directed to a thermoplastic elastomeric composition having improved film processing characteristics over previously known similar compositions.

The present invention is directed to a dynamically vulcanized alloy containing at least one isobutylene-based elastomer, at least one thermoplastic resin, a cure system, and a lubricant system. The lubricant system contains a metal organic salt and a fatty acid having a phr ratio range of metal organic salt to fatty acid of 0.75:1 to 10:1. In the alloy, the elastomer is present as a dispersed phase of small vulcanized or partially vulcanized particles in a continuous phase of the thermoplastic resin. In any aspect of the invention, the lubricant system is present in the final DVA in an amount in the range of 0.75 to 9.0 phr based on the amount of curable elastomer in the DVA.

The alloy may contain a mixture of thermoplastic resins, wherein the relative viscosities of the different thermoplastic resins are different, but wherein the relative viscosity of the mixture is not more than 3.9. The relative viscosity of the thermoplastic resin, either as a single component or a mixture of resins, is not less than 2.0. Thermoplastic resins useful in any embodiment may be copolymers or homopolymers.

Also disclosed herein and useful in any embodiment of the present invention, the elastomer may be a halogenated butyl rubber or a halogenated polymer of isobutylene derived units and alkylstyrene derived units. In any embodiment, when the elastomer is a halogenated polymer of isobutylene derived units and alkylstyrene, the polymer comprises 7 to 12 wt % of alkylstyrene, preferably paramethylstyrene. In any embodiment, the elastomer may contain 1.0 to 1.5 mol % of a halogen; the halogen may be bromine or chlorine.

The present invention is also directed to a blown film or extruded cast sheet prepared from the lubricant containing DVA. The DVA film has an improved appearance and less gels in comparison to films formed from DVAs lacking the lubricant system of the present invention.

Disclosed herein are methods of preparing the DVA wherein interference of the curing of the elastomer via the cure system is minimized by the composition, method and or timing of the addition of the lubricant system to the DVA. The lubricant system may be added to the mixer or extruder preparing the DVA at the same time as the curative injection, after the curing of the elastomer has been initiated, or after the curing of the elastomer has progressed to substantial completion, defined as 90% of the final cure state, as determined by the cure profile of the elastomer and cure system.

### BRIEF DESCRIPTION OF THE DRAWINGS

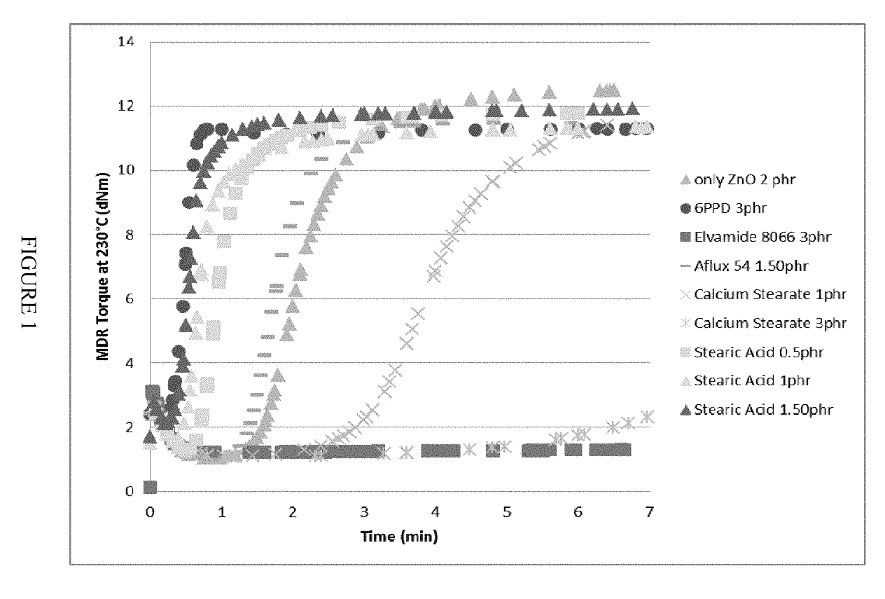

The invention will be described by way of example and with reference to the accompanying FIGS. 1 to 3 which are moving die rheometer, MDR Torque vs time plots, i.e. cure profiles, for elastomers with different curative amounts and different additives.

### DETAILED DESCRIPTION OF THE INVENTION

The present invention is directed to thermoplastic elastomer composition having the elastomer present in the composition as discreet domains in a thermoplastic resin matrix wherein to maintain the desired morphology of the DVA and achieve the desired post-formation processability of the DVA, the composition contains a lubricant package of specific materials and a defined ratio between the lubricant compounds.

The DVA composition is substantially free of sulfonamides wherein ‘substantially free’ is defined as less than 100 ppm by weight of the sulfonamide. The composition is also essentially devoid of fugitive plasticizers such as benzyl butyl sulfonamide, BBSA.

Various specific embodiments, versions, and examples of the invention will now be described, including preferred embodiments and definitions that are adopted herein for purposes of understanding the claimed invention. While the illustrative embodiments have been described with particularity, it will be understood that various other modifications will be apparent to and can be readily made by those skilled in the art without departing from the spirit and scope of the invention. For determining infringement, the scope of the “invention” will refer to any one or more of the appended claims, including their equivalents and elements or limitations that are equivalent to those that are recited.

### Definitions

Definitions applicable to the presently described invention are as described below.

Polymer may be used to refer to homopolymers, copolymers, interpolymers, terpolymers, etc. Likewise, a copolymer may refer to a polymer comprising at least two monomers, optionally with other monomers. When a polymer is referred to as comprising a monomer, the monomer is present in the polymer in the polymerized form of the monomer or in the polymerized form of a derivative from the monomer (i.e., a monomeric unit). However, for ease of reference the phrase comprising the (respective) monomer or the like is used as shorthand. Likewise, when catalyst components are described as comprising neutral stable forms of the components, it is well understood by one skilled in the art, that the ionic form of the component is the form that reacts with the monomers to produce polymers.

Elastomer refers to any polymer or composition of polymers consistent with the ASTM D1566 definition: “a material that is capable of recovering from large deformations, and can be, or already is, modified to a state in which it is essentially insoluble, if vulcanized, (but can swell) in a solvent.” Elastomers are often also referred to as rubbers; the term elastomer may be used herein interchangeably with the term rubber.

The term “phr” is parts per hundred rubber or “parts”, and is a measure common in the art wherein components of a composition are measured relative to a total of all of the elastomer components. The total phr or parts for all rubber components, whether one, two, three, or more different rubber components is present in a given recipe is normally defined as 100 phr. In some instances, the rubber components comprising the 100 phr may be limited to only the rubber intended to be cross-linked during further processing of the composition. All other components are ratioed against the 100 parts of rubber and are expressed in phr. This way one can easily compare, for example, the levels of curatives or filler loadings, etc., between different compositions based on the same relative proportion of rubber without the need to recalculate percentages for every component after adjusting levels of only one, or more, component(s).

Isoolefin refers to any olefin monomer having at least one carbon having two substitutions on that carbon. Multiolefin refers to any monomer having two or more double bonds. In a preferred embodiment, the multiolefin is any monomer comprising two conjugated double bonds such as a conjugated diene like isoprene.

Isobutylene based elastomer or polymer refers to elastomers or polymers comprising at least 70 mol % repeat units derived from isobutylene monomers.

### Elastomer

Useful elastomeric compositions for this invention include elastomers derived from a mixture of monomers, the mixture having at least (1) a C₄ to C₇ isoolefin monomer component with (2) a polymerizable component. The isoolefin is present in a range from 70 to 99.5 wt % by weight of the total monomers in any embodiment, or 85 to 99.5 wt % in any embodiment. The polymerizable component, either a multiolefin or a styrene derived polymerizable component, is present in amounts in the range of from 30 to about 0.5 wt % in any embodiment, or from 15 to 0.5 wt % in any embodiment, or from 12 to 5 wt %, or from 8 to 0.5 wt % in any embodiment.

The isoolefin monomer is a C₄ to C₇ compound, non-limiting examples of which are isobutylene, 2-methyl-1-butene, 3-methyl-1-butene, 2-methyl-2-butene, 1-butene, 2-butene, methyl vinyl ether, indene, hexene, and 4-methyl-1-pentene. The multiolefin is a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene. The styrene derived polymerizable component may be styrene, alkylstyrene, or dichlorostyrene or other styrene derived units suitable for homopolymerization or copolymerization in butyl rubbers. Polymers derived from the noted isoolefin monomers, multiolefin monomers, and/or styrene derived units have been referred to as butyl or butyl-type rubbers.

Preferred elastomers useful in the practice of this invention include isobutylene-based copolymers. As stated above, an isobutylene based elastomer or a polymer refers to an elastomer or a polymer comprising at least 70 mol % repeat units from isobutylene and at least one other polymerizable unit. The isobutylene-based copolymer may or may not be halogenated with 0.5 to 2.0 mol % halogen.

In any embodiment of the invention, the elastomer may be a butyl-type rubber or branched butyl-type rubber, especially halogenated versions of these elastomers. Useful elastomers are unsaturated butyl rubbers such copolymers of olefins or isoolefins and multiolefins. Non-limiting examples of unsaturated elastomers useful in the method and composition of the present invention are butyl rubber, poly(isobutylene-co-isoprene), poly(styrene-co-butadiene), natural rubber, star-branched poly(isobutylene-co-isoprene) rubber, isobutylene-isoprene-alkylstyrene terpolymers and mixtures thereof. The butyl rubber is obtained by reacting isobutylene with 0.5 to 8 wt % isoprene, or reacting isobutylene with 0.5 wt % to 5.0 wt % isoprene—the remaining weight percent of the polymer being derived from isobutylene. Useful elastomers in the present invention can be made by any suitable means known in the art, and the invention herein is not limited by the elastomer production method.

Elastomers useful in the present invention include random copolymers derived from a C₄ to C₇ isoolefin and an alkylstyrene comonomer. The isoolefin may be selected from any of the above listed C₄ to C₇ isoolefin monomers, and is preferably an isomonoolefin, and in any embodiment may be isobutylene. The alkylstyrene derived units are present from 5 to 15 wt %, or 7 to 12 wt %, based on the total weight of the polymer with the remainder units being derived from the C₄ to C₇ isoolefin. The random copolymer may optionally include functionalized interpolymers. The functionalized interpolymers have at least one or more of the alkyl substituents groups present in the styrene monomer units; the substituent group may be a benzylic halogen or other functional group. The alkylstyrene comonomer may be para-methylstyrene containing at least 80%, alternatively at least 90% by weight, of the para-isomer. The random comonomer may optionally include functionalized interpolymers wherein at least one or more of the alkyl substituents groups present in the styrene monomer units contain benzylic halogen or some other functional group. Exemplary materials of any embodiment may be characterized as polymers containing the following alkylstyrene derived monomer units randomly spaced along the polymer chain:

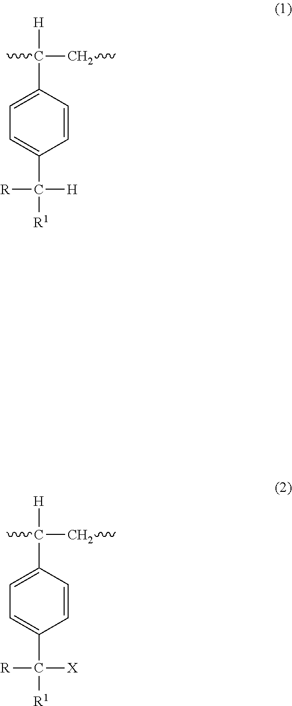

wherein R and R¹ are independently hydrogen, lower alkyl, such as a C₁ to C₇ alkyl and primary or secondary alkyl halides and X is a functional group such as halogen, acid, or an ester. In an embodiment, R and R¹ are both hydrogen. Up to 60 mol % of the para-substituted styrene present in the random polymer structure may be the functionalized structure (2) above in any embodiment. Alternatively, in any embodiment, from 0.1 to 5 mol % or 0.2 to 3 mol % of the para-substituted styrene present may be the functionalized structure (2) above.

The functional group X may be halogen or some other functional group which may be incorporated by nucleophilic substitution of any benzylic halogen with other groups such as carboxylic acids; carboxy salts; carboxy esters, amides and imides; hydroxy; alkoxide; phenoxide; thiolate; thioether; xanthate; cyanide; cyanate; amino and mixtures thereof. The functionality is selected such that it can react or form polar bonds with functional groups present in the DVA matrix polymer, for example, acid, amino or hydroxyl functional groups, when the DVA polymer components are mixed at high temperatures. These functionalized isomonoolefin copolymers, their method of preparation, methods of functionalization, and cure are more particularly disclosed in U.S. Pat. No. 5,162,445.

Brominated poly(isobutylene-co-p-methylstyrene) “BIMSM” polymers useful in the present invention generally contain from 0.1 to 5 mol % of bromomethylstyrene groups relative to the total amount of monomer derived units in the copolymer. Suitable BIMSM polymers contain bromomethyl groups in an amount from 0.5 to 3.0 mol %, or from 0.3 to 2.8 mol %, or from 0.4 to 2.5 mol %, or from 0.5 to 2.0 mol %, or 1.0 to 2.0 mol %, or 1.0 to 1.5 mol %. Expressed another way, exemplary BIMSM polymers useful in the present invention contain from 0.2 to 10 wt % of bromine, based on the weight of the polymer, or from 0.4 to 6 wt % bromine, or from 0.6 to 5.6 wt %. Useful BIMSM polymers may be substantially free of ring halogen or halogen in the polymer backbone chain.

### Thermoplastic Resin

For purposes of the present invention, a thermoplastic (alternatively referred to as thermoplastic resin) is a thermoplastic polymer, copolymer, or mixture thereof having a Young's modulus of more than 200 MPa at 23° C. The resin should have a melting temperature of about 170° C. to about 260° C., preferably less than 260° C., and most preferably less than about 240° C. By conventional definition, a thermoplastic resin is a synthetic resin that softens when heat is applied and regains its original properties upon cooling.

Such thermoplastic resins may be used singly or in combination and generally contain nitrogen, oxygen, halogen, sulfur or other groups capable of interacting with an aromatic functional groups such as halogen or acidic groups. Suitable thermoplastic resins include resins selected from the group consisting of polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK), ethylene copolymer resins (EVA or EVOH) and mixtures thereof.

Suitable polyamides (nylons) comprise crystalline or resinous, high molecular weight solid polymers including copolymers and terpolymers having recurring amide units within the polymer chain. Polyamides may be prepared by polymerization of one or more epsilon lactams such as caprolactam, pyrrolidione, lauryllactam and aminoundecanoic lactam, or amino acid, or by condensation of dibasic acids and diamines Both fiber-forming, extrusion and molding grade nylons are suitable. Examples of such polyamides are polycaprolactam (nylon-6), polylauryllactam (nylon-12), polyhexamethyleneadipamide (nylon-6,6) polyhexamethyleneazelamide (nylon-6,9), polyhexamethylenesebacamide (nylon-6,10), polyhexamethyleneisophthalamide (nylon-6, IP) and the condensation product of 11-amino-undecanoic acid (nylon-11). Also suitable and preferred are polyamide copolymers such as nylon 6,66. Commercially available polyamides may be advantageously used in the practice of this invention, with linear crystalline polyamides having a softening point or melting point between 160 and 260° C. being preferred.

Suitable polyesters which may be employed include the polymer reaction products of one or a mixture of aliphatic or aromatic polycarboxylic acids esters of anhydrides and one or a mixture of diols. Examples of satisfactory polyesters include poly (trans-1,4-cyclohexylene C₂₋₆ alkane dicarboxylates such as poly(trans-1,4-cyclohexylene succinate) and poly (trans-1,4-cyclohexylene adipate); poly (cis or trans-1,4-cyclohexanedimethylene) alkanedicarboxylates such as poly(cis-1,4-cyclohexanedimethylene) oxlate and poly-(cis-1,4-cyclohexanedimethylene) succinate, poly (C₂₋₄ alkylene terephthalates) such as polyethyleneterephthalate and polytetramethylene-terephthalate, poly (C₂₋₄ alkylene isophthalates such as polyethyleneisophthalate and polytetramethylene-isophthalate and like materials. Preferred polyesters are derived from aromatic dicarboxylic acids such as naphthalenic or phthalic acids and C₂ to C₄ diols, such as polyethylene terephthalate and polybutylene terephthalate. Preferred polyesters will have a melting point in the range of 160° C. to 260° C.

Poly(phenylene ether) (PPE) resins which may be used in accordance with this invention are well known, commercially available materials produced by the oxidative coupling polymerization of alkyl substituted phenols. They are generally linear, amorphous polymers having a glass transition temperature in the range of 190° C. to 235° C.

Ethylene copolymer resins useful in the invention include copolymers of ethylene with unsaturated esters of lower carboxylic acids as well as the carboxylic acids per se. In particular, copolymers of ethylene with vinylacetate or alkyl acrylates for example methyl acrylate and ethyl acrylate can be employed. These ethylene copolymers typically comprise about 60 to about 99 wt % ethylene, preferably about 70 to 95 wt % ethylene, more preferably about 75 to about 90 wt % ethylene. The expression “ethylene copolymer resin” as used herein means, generally, copolymers of ethylene with unsaturated esters of lower (C₁-C₄) monocarboxylic acids and the acids themselves; e.g., acrylic acid, vinyl esters or alkyl acrylates. It is also meant to include both “EVA” and “EVOH”, which refer to ethylene-vinylacetate copolymers, and their hydrolyzed counterpart ethylene-vinyl alcohols.

### Thermoplastic Elastomeric Composition

At least one of any of the above elastomers and at least one of any of the above thermoplastics are blended to form a dynamically vulcanized alloy. The term “dynamic vulcanization” is used herein to connote a vulcanization process in which the vulcanizable elastomer is vulcanized in the presence of a thermoplastic under conditions of high shear and elevated temperature. As a result, the vulcanizable elastomer is simultaneously crosslinked and preferably becomes dispersed as fine sub micron size particles of a “micro gel” within the thermoplastic. The small vulcanized or partially vulcanized elastomeric particles have a particle size of not more than 10 Sub-inclusions of the thermoplastic inside the rubber particles may also be present, though the principal amount of thermoplastic will be continuous.

Dynamic vulcanization is effected by mixing the ingredients at a temperature which is at or above the curing temperature of the elastomer, and also above the melt temperature of the thermoplastic component, in equipment such as roll mills, Banbury™ mixers, continuous mixers, kneaders or mixing extruders, e.g., Buss kneaders, twin or multiple screw extruders. The unique characteristic of the dynamically cured compositions is that, notwithstanding the fact that the elastomer component may be fully cured, the compositions can be processed and reprocessed by conventional thermoplastic processing techniques such as film blowing, film casting, extrusion, injection molding, compression molding, etc. Scrap or flashing can also be salvaged and reprocessed; those skilled in the art will appreciate that conventional elastomeric thermoset scrap, comprising only elastomer polymers, cannot readily be reprocessed due to the cross-linking characteristics of the vulcanized polymer.

Preferably thermoplastic resin is present in the DVA in an amount ranging from about 10 to 98 wt %, preferably from about 20 to 95 wt %, the elastomer may be present in an amount ranging from about 2 to 90 wt %, preferably from about 5 to 80 wt %, based on the polymer blend. For elastomeric-rich blends, the amount of thermoplastic resin in the polymer blend is in the range of 45 to 10 wt %, and the elastomer is present in the amount of 90 to 55 wt %.

The elastomer may be present in the composition in a range up to 90 wt % in any embodiment, or up to 80 wt % in any embodiment, or up to 70 wt % in any embodiment. In the invention, the elastomer may be present from at least 10 wt %, and from at least 15 wt % in another embodiment, and from at least 20 wt % in yet another embodiment. A desirable embodiment may include any combination of any upper wt % limit and any lower wt % limit.

In preparing the DVA, other materials are blended with either the elastomer or the thermoplastic, before the elastomer and the thermoplastic are combined in the blender or added to the mixer during or after the thermoplastic and elastomer have already been introduced to each other. These other materials are added to assist with preparation of the DVA or to provide desired morphology and/or physical properties to the DVA or to provide desired processing or final article properties when forming articles from the DVA.

### Compatibilizer/Plasticizer

Minimizing the viscosity differential between the elastomer and the thermoplastic resin components during mixing and/or processing enhances uniform mixing and fine blend morphology that significantly enhance good blend mechanical as well as desired permeability properties. However, as a consequence of the flow activation and shear thinning characteristic inherent in elastomeric polymers, reduced viscosity values of the elastomeric polymers at the elevated temperatures and shear rates encountered during mixing are much more pronounced than the reductions in viscosity of the thermoplastic component with which the elastomer is blended. This viscosity difference is reduced between the materials to achieve a DVA with acceptable elastomeric dispersion sizes.

Components used to compatibilize the viscosity between the elastomer and thermoplastic components include plasticizers such as non-preferred butyl benzyl sulfonamide (BBSA), low molecular weight polyamides, maleic anhydride grafted polymers having a molecular weight on the order of 10,000 or greater, methacrylate copolymers, tertiary amines and secondary diamines. One common group of compatibilizers is maleic anhydride-grafted ethylene-ethyl acrylate copolymers (a solid rubbery material available from Mitsui-DuPont as AR-201 having a melt flow rate of 7 g/10 min measured per JIS K6710). These compounds act to increase the ‘effective’ amount of thermoplastic material in the elastomeric/thermoplastic compound. The amount of additive is selected to achieve the desired viscosity comparison without negatively affecting the characteristics of the DVA. If too much is present, impermeability may be decreased and the excess may have to be removed during post-processing. If not enough compatibilizer is present, the elastomer may not invert phases to become the dispersed phase in the thermoplastic resin matrix.

The desired compatibility between the elastomer and thermoplastic resin can also be obtained by the use of a medium relative viscosity polyamide or blends of high and medium relative viscosity polyamides and/or low relatively viscosity polyamides in combination with a low molecular weight anhydride functionalized oligomer (AFO). For optimum balance of durability versus processability it may be desirable to minimize or even eliminate the low molecular weight polyamide, i.e., those having a MW of less than 10,000. When the use of medium relative viscosity polyamide or a mixture of polyamides to achieve a medium relative viscosity is selected, low molecular weight polyamide is present in the composition in an amount of 0 to 5 wt % of the total composition, preferably 0 to 3 wt %, more preferably 0 wt % of the total composition; expressed alternatively, the amount of low molecular weight polyamide in the invention is 0 to 10 wt %, preferably 0 to 5 wt %, more preferably 0 wt %, of the total ‘effective amount’ of thermoplastic components in the compound.

The terminology of high, medium and low viscosity polyamide is defined in terms of relative viscosity, calculated per ASTM D2857 and is the ratio of the viscosity of the solution to the viscosity of the solvent in which the polymer is dissolved, as specified in exemplary polyamides raw material useful for this invention and shown in Table 1 below.

TABLE 1

| Polyamide | Comonomer Ratio | Relative Viscosity (1% | Viscosity | |
|---|---|---|---|---|
| Grades | PA6/PA66, % | in 96% H₂SO₄ at 23° C.) | Classification | Commercial Source |
| PA 6/66 | 85/15 | 4.1 | High | UBE 5033B |
| PA 6/66 | 80/20 | 3.4 | Medium | UBE 5024B |
| PA 6/66 | 85/15 | 2.5 | Low | UBE 5013B |
| PA 6/66 | 85/15 | 2.3 | Low | Novamid 2010 |
| PA 6/66 | 80/20 | 3.3 | Intermediate | Ultramid C33 01 |
| PA 6/66 | 80/20 | 3.1 | Intermediate | Ultramid C31 01 |
| PA 6 | 100/0 | 2.7 | Low | Ultramid B27 |
| PA 6 | 100/0 | 2.5 to 2.74 | Low | Ultramid B26 HM 01 |

When the relative viscosity is at or above 4.0, the resin has a relative viscosity classification of high. When the relative viscosity is in the range of 3.4 to 3.9, the resin has a relative viscosity classification of medium. When the relative viscosity is in the range of 2.9 to 3.3, the resin has a relative viscosity classification of intermediate and may also be classified as medium or low. For resin having a relative viscosity below 2.9, the resin has a relative viscosity classification of low, with those below 2.0 being classified as ultra-low.

In any embodiment of the present invention, a thermoplastic copolymer or homopolymer having a relative viscosity lower than the primary thermoplastic component is used to aid in reduction of the viscosity of the thermoplastic during mixing of the DVA. When added, the amount of relatively lower viscosity thermoplastic is in the range of 5 to 25 percent of the total thermoplastic resin present in the composition. This results in a thermoplastic viscosity that is relatively low in comparison to the viscosity of the elastomer during mixing and/or processing. For high relative viscosity (RV) grades of thermoplastic resin, the thermoplastic resin may require a greater amount of compatibilizers in the alloy. Whether the thermoplastic component of the DVA is a single medium relative viscosity thermoplastic resin or a mixture of two or more thermoplastic resins, the thermoplastic resin, preferably polyamide, should have a relative viscosity in the range in the range of 3.9 to 2.9, preferably in the range of 3.5 to 2.9.

To obtain the desired morphology in elastomer-rich compositions, i.e. greater than 55 wt % elastomer in the composition, the viscosity of the thermoplastic plus the AFO should be lower than the viscosity of the elastomer. Anhydride moieties, both maleic and succinic anhydride moities, have an affinity and compatibility with the thermoplastics employed in the compositions of this invention. The anhydrides are miscible or sufficiently compatible with the thermoplastic and graft to the thermoplastic, such grafting may occur as the anhydride acts as a scavenger for any terminal amines in the thermoplastic. As the AFO grafts with the thermoplastic resin during mixing of the DVA, the AFO is added into the mixer/extruder simultaneously with the thermoplastic resin or as the thermoplastic resin begins to melt in the mixer/extruder. The grafted anhydride functionalized oligomer is fixed within the DVA, and does not volatilize out during post DVA processing operations such as film blowing or tire curing. This grafting is more favorable when using polar thermoplastics.

Both maleic and succinic anhydrides functionalized oligomers are useful in the DVA composition. The anhydride functionalized oligomer may be prepared by thermal or chloro methods known in the art of reacting an alkyl, aryl, or olefin oligomer with anhydride, preferably maleic anhydride. The AFO prepared by thermal process may be preferred to those made by the chloro process. Prior to functionalization with the anhydride, the oligomer, including copolymers of lower olefins, has a molecular weight in the range of about 500 to 5000, or 500 to 2500, or 750 to 2500, or 500 to 1500. The oligomer, prior to anhydride functionalization, may also have a molecular weight in the ranges of 1000 to 5000, 800 to 2500, or 750 to 1250. Specific examples of succinic anhydrides include poly-isobutylene succinic anhydride (PIBSA), poly-butene succinic anhydride, n-octenyl succinic anhydride, n-hexenyl succinic anhydride, and dodocenyl succinic anhydride.

The anhydride level of the AFO of the invention may vary and a preferred range is a few percent up to about 30 wt % with a preferred range of 5 to 25 wt % and a more preferred range of 7 to 17 wt % and a most preferred range of 9 to 15 wt %.

As the amount of AFO is increased, the shear viscosity versus the shear rate is reduced, indicating there will be a lowering of the viscosity of the thermoplastic mixture by inclusion of the AFO to the thermoplastic during mixing of the DVA. The use of an AFO results in only a minimal change in the melt temperature of the polyamide.

The AFO, preferably succinic anhydride functionalized oligomers of low molecular weight, are present in the DVA in amounts ranging from a minimum amount of about 2 phr, 5 phr, 8 phr, or 10 phr to a maximum amount of 12 phr, 15 phr, 20 phr, 25 phr, or 30 phr. The range of anhydride may range from any of the above stated minimums to any of the above stated maximums, and the amount of anhydride may fall within any of the ranges.

In any embodiment of the invention, the composition is also substantially free of volatile compatibilizers which are capable of being volatized out of the composition during formation of the DVA or during film or sheet formation of the DVA or other heating of the DVA material regardless of the material form, i.e. pellet, sheet, or film. Such known volatile compatibilizers include sulfonamides, such as n-butyl benzene sulfonamide (BBSA). In any embodiment, ‘substantially free of volatile compatibilizers’ or ‘substantially free of sulfonamides’ is defined as less than 100 ppm by weight of the volatile compatibilizer or sulfonamide.

### Cure System

With reference to the elastomers of the disclosed invention, “vulcanized” or “cured” refers to the chemical reaction that forms bonds or cross-links between the polymer chains of the elastomer. The vulcanizable rubbers will be cured to at least 50% of the maximum state of cure of which they are capable based on the cure system, time and temperature, and typically, the state of cure of such rubbers will exceed 50% of maximum cure. If the rubber(s) added in one stage is cured to not more than 50% of their maximum, it is possible for dispersed rubber particles to coalesce into larger size particles during further downstream mixing or heating operations, which is undesirable. Conversely, it may be desirable to cure the rubber particles to less than the maximum state of cure of which the rubber is capable so that the flexibility, as measured, for example, by Young's modulus, of the rubber component is at a suitable level for the end-use to which the composition is to be put, e.g., a tire innerliner or hose component. Consequently, it may be desirable to control the state of cure of the rubber(s) used in the composition to be less than or equal to about 95% of the maximum degree of cure of which they are capable, as described above.

Curing of the elastomer is generally accomplished by the incorporation of cure agents/components, wherein the overall mixture of cure agents referred to as the cure system or cure package. In a DVA, due to the goal of the elastomer being present as discrete small particles in a thermoplastic domain, the addition of the cure system components and the temperature profile of the components are adjusted to ensure the correct morphology is developed. Thus, if there are multiple mixing or addition stages in the preparation of the DVA, the curatives may be added during an earlier stage wherein the elastomer alone is being prepared. Alternatively, the curatives may be added just before the elastomer and thermoplastic resin are combined or even after the thermoplastic has melted and been mixed with the rubber.

In the present DVA, the cure system provides for a step-wise cure profile wherein curing is delayed to permit grafting of the oligomer and greater dispersion of the curative in the mixer and into the elastomer. When cured at 220° C., the DVA elastomer requires at least three minutes of mixing to achieve a ten percent cure in “quasi static” vulcanization measured by the moving die rheometer and achieves at least a seventy five percent cure of the elastomer in less than 15 minutes. One skilled in the art will appreciate that for higher curing temperatures and especially in dynamic vulcanization, these cure times will be reduced; however, the step-wise cure profile of the present invention, as opposed to a gradual cure after a fast initiation of the cure, is still obtained.

In accordance with any embodiment, at 220° C., the compound obtains, in a static cure, at least a 75% elastomeric cure in less than 15 minutes in one embodiment, or in not more than 10 minutes in another embodiment. In another embodiment, the compounds require at least 3 minutes to obtain 10% cure. In other embodiments, the compounds require at least 4.5 minutes, at least 5 minutes, or at least 6 minutes to obtain 10% cure. All of the above cure times are based on measurements by a low shear moving die rheometer set at 1 degree arc and 100 cycles per minute (cpm) (˜10.4 rad/s) using test method ASTM D 5289-95 (2001).

This cure profile is obtained by the use of a simplified cure system using metal oxides in amounts of 0.5 to 10 phr, based on the weight percent of the total effective, i.e., cross-linking, rubber in the thermoplastic elastomer. In embodiments, the curative is present in the composition in amounts of 1.0 to 10 phr or 1.5 to 10 phr; in yet another embodiment, the curative is present in the composition in amounts of 1.5 to 8 phr; and in yet another embodiment, the curative is present in amounts of 2 to 8 phr, and in yet another embodiment, the curative is present in amounts of 3 to 8 phr. Exemplary metal oxides are zinc oxide, CaO, BaO, MgO, Al₂O₃, CrO₃, FeO, Fe₂O₃, and NiO.

### Lubricant System

As discussed in U.S. Pat. No. 8,415,431, the step-wise cure profile of the elastomer is achieved when the DVA composition, or cure package thereof, contains not more than 0.1 phr of cure accelerators. While the DVA disclosed in U.S. Pat. No. 8,415,431 evidences excellent film blowing capability, improvements in the processability for final films formed therefrom are required to achieve the final desired products having a smooth surface, lower defect amounts, and very low gel content especially in compositions without BBSA or other volatile compatibilizers.

To that end, Applicant investigated the addition, alone and in combinations, of various additives, lubricants, and processing aids commonly used in the rubber and plastics industry, as well as low molecular weight polyamides and low molecular weight nylon oligomer process additives. Applicant sought additives that could achieve the desired improvements in blown/cast film processability with minimum interference, or debits, to the synthesis chemistry of the DVA and particularly to cure chemistry as it relates to kinetics and cure state, and tire performance properties.

It was found that combinations of common vulcanization chemicals; particularly metal organic salts and fatty acid mixtures played a secondary role as a lubricant when incorporated in DVA compositions at unconventional higher amounts and different relative ratios. Resulting in the extrusion blown and cast films being unexpectedly essentially smooth and defect free with very low gel content. Combinations and dosage are critical to achieve the best balance of performance and processability for extrusion blown and cast film. As surprisingly discovered by Applicants, it is a combination of an additive that acts as a cure retardant and an additive that acts as a cure accelerant provided the desired balance of processability and performance. These two components together form what is referred to, for the purpose of this patent application, a lubricant system.

Cure retardants useful in accordance with the invention are metal organic salts (metal being determined by the Periodic Table), preferably metal organic salts that are stearates. Exemplary metal stearates are stearate salts of zinc, calcium, magnesium, barium and aluminum.

Cure accelerants useful in accordance with the invention are fatty acids, preferably saturated fatty acids having a total carbon count number in the range of 10 to 26. Alternatively, the fatty acid has a total carbon count number in the range of 12 to 24 or 16 to 24.

As noted above, it is not merely the presence of such compounds, known as useful in elastomeric curative systems, that provide the unexpected improvement in the DVA characteristics, but also the amount of each component in the lubricant system, the total amount of lubricant system in the DVA, and the amount of lubricant system relative to the cure system used in the DVA. A series of elastomeric samples with varying amounts of the lubricant system components were prepared and cured in the moving die rheometer, generating curves (torque versus time) of the samples. The torque was measured at 230° C. to determine the response of the compounds during post forming operations such as film blowing or casting which typically occurs at temperatures equal or greater than the elastomeric cure temperature reached when mixing the compounds.

FIG. 1 has the rheometer curves, measured at 230° C. for a series of samples wherein all the samples were compounded with the same elastomer, a BIMSM polymer of 5 wt % para-methylstyrene (PMS), 0.75 mol % brPMS, and a Mooney viscosity MU (1+8, 125° C.) of 45, and 2 phr of zinc oxide. Various amounts of singular additional additives were added to determine the effect on the cure relative to the known favorable cure profile of the elastomer and only a zinc oxide. The additives are identified in Table 2 below:

TABLE 2

| Compound | Chemical structure | Supplier |
|---|---|---|
| 6PPD | N-(1,3-dimethylbutyl)-N′- | Various |
| | phenyl-p-phenylenediamine | |
| Elvamide^{R} 8066 | Nylon thermoplastic | DuPont |
| Aflux^{R} 54 | Mix of pentaerythrityltri- and | Rhein Chemie |
| | tetrastearate | |
| Calcium stearate | | Various |
| Stearic acid | | Various |

The MDR curve for the elastomer containing only 2 phr ZnO has a stepped profile wherein torque is initially reduced, is relatively constant for about one minute, and then begins to increase at about 1.5 minutes, and reaches relatively full cure at about 3 minutes; this curve is considered the baseline comparative curve for the following analysis. As appreciated by those in the art, rheometer curves are indicative of cure behavior of elastomers and, in the context of the present DVA compositions, will predict how the elastomer will behave and cure in the extruder during DVA formation. The following points are evident from the MDR cure profile curves of FIG. 1:

a. the use of 3 phr of 6PPD, a common cure accelerant, results in an almost immediate total cure of the elastomer, eliminating a desired delay in elastomer curing to provide time for interfacial grafting of the elastomer and thermoplastic resins when forming the DVA; lesser amounts of 6PPD may push the curve profile closer to the baseline curve;

b. the inclusion of Elvamide® halted curing of the elastomer, interfering with any curing normally achieved by the zinc oxide;

c. the addition of 1.5 phr Aflux® a stearate blend, resulted in a profile comparable to that of the baseline rheometer curve, with a minor reduction in the cure delay time;

d. the addition of calcium stearate in an amount of 1 phr delayed the onset of cure, acting as a cure retardant, and would thus provide time for interfacial grafting of the elastomer and thermoplastic resins; the addition of calcium stearate in greater amounts significantly slowed down the cure time, exposing the elastomer to an extended heat history and potentially incomplete cure before the DVA is discharged from a forming extruder; and

e. increasing amounts of stearic acid, another common cure accelerant, reduced cure times of the elastomer, with the addition of 1.5 phr stearic acid resulting in a curve comparable to the addition of 3 phr of 6PPD.

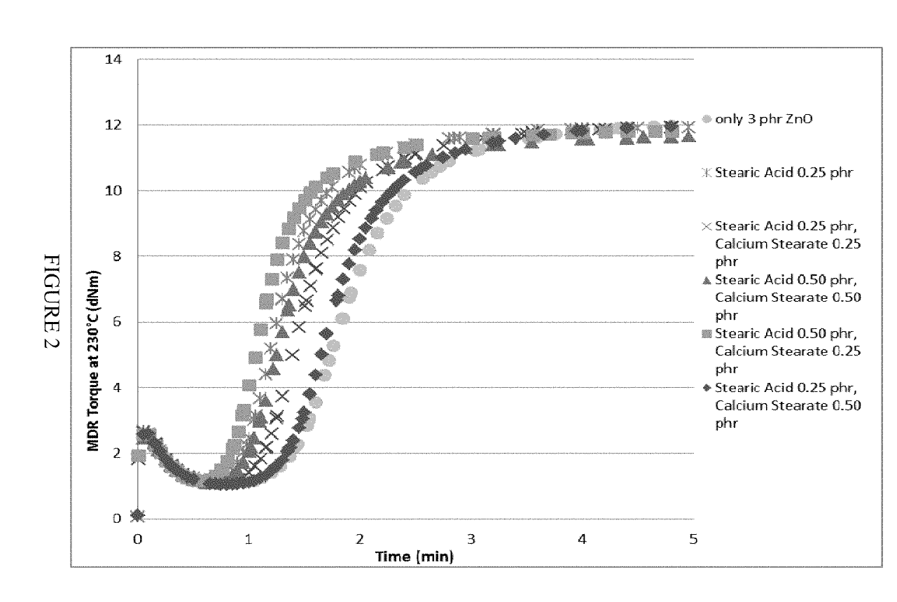

As certain additives increased cure times while others retarded or delayed cure times, as seen in FIG. 1, another set of samples were prepared wherein both a cure retardant and a cure accelerant are combined in different amounts and combinations. The resulting rheometers curves are shown in FIG. 2. The curve for the elastomer containing only 3 phr of zinc oxide is the baseline curve for FIG. 2. The following points are evident from the curves:

a. the addition of 0.25 phr stearic acid, as before, accelerated the cure rates, with the desired interfacial grafting time terminating at approximately 0.75 mins;

b. the inclusion of an equal amount of calcium stearate delayed the cure rate relative to adding only stearic acid but the resulting cure was still faster than the baseline cure rate;

c. doubling the equal amounts of the stearic acid and calcium stearate actually reduced the desired time for interfacial grafting and resulted in a faster cure—indicating the effect of the acid was dominating any delay in cure due to a corresponding increase in the amount of stearate;

d. using twice the amount of acid to the stearate yielded the fastest cure rate—not desirable for the desired DVA morphology; and

e. using twice the amount of stearate to acid resulted in a cure profile almost identical to that of the base line, i.e. cure neutral, indicating the desired DVA morphology would be obtainable when using a greater amount of stearate, i.e., a cure retardant, than cure accelerant.

Prior disclosed DVA compositions have provided for various ranges of curatives and common curative compounds and disclosed exemplary curative packages. These prior cure systems have been based on conventional elastomeric compound curative packages and when using both a stearate and an acid have used an acid:stearate ratio of about 2:1. Prior art cure packages include i) 0.15 phr zinc oxide, 0.3 phr zinc stearate and 0.65 stearic acid [an acid:stearate ratio of >2; see U.S. Pat. No. 8,809,455], ii) 0.15 phr zinc oxide, 0.3 phr zinc stearate and 0.7 stearic acid [control compound in U.S. Pat. No. 8,415,431] and iii) 0.45 phr zinc oxide, 0.9 phr zinc stearate, and 2.1 phr stearic acid [compound B in U.S. Pat. No. 8,415,431]. U.S. Pat. No. 8,415,431 provides the MDR cure profiles for these compounds. While using less zinc oxide than in FIGS. 1 and 2, U.S. Pat. No. 8,415,431, the cure profiles for the Control and Compound B in U.S. Pat. No. 8,415,431 evidence a faster cure with a reduced time for desired interfacial grafting.

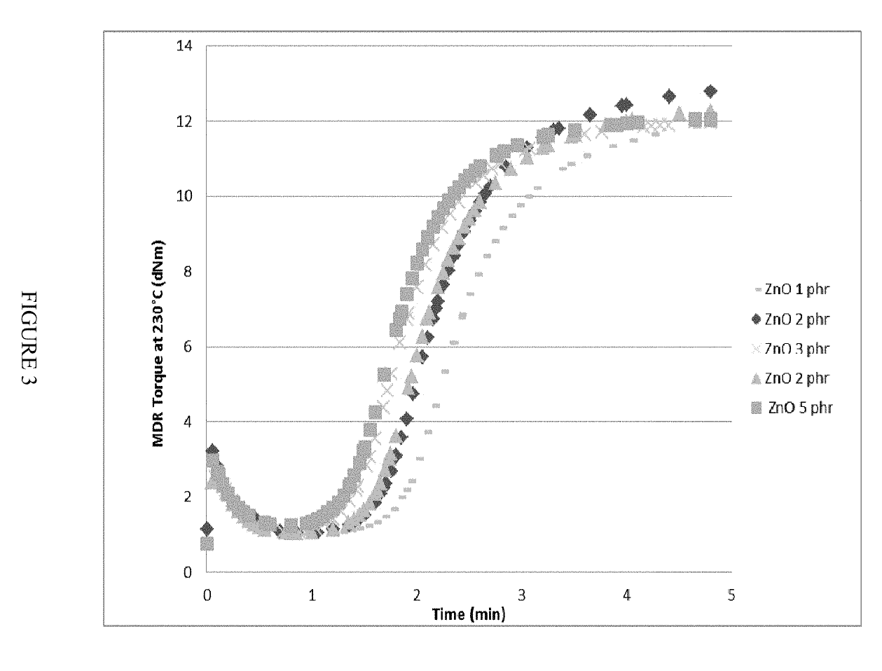

The samples of FIG. 1 were prepared using 2 phr ZnO, while those of FIG. 2 were prepared using 3 phr ZnO. FIG. 3 shows the variation in the cure rate for the same elastomer incorporating only ZnO to demonstrate the differences in cure profile/rate as the ZnO amount is varied. Not unexpectedly, the slowest rates are with 1 phr, and fastest is with the sampled 5 phr. What is surprising is that the variation in cure rate from 3 phr to 5 phr is not greater than that demonstrated by the curves as would be expected when stepwise increasing the ZnO phr amounts. Given the relative data in FIG. 3, it can be predicted that the cure profiles of FIGS. 1 and 2 would be achieved when varying the amount of zinc oxide in the range of one to three phr.

Attempts were also made to mitigate the debits on the cure characteristics inferred by the lubricants by moving their point of addition during manufacture of the DVA in the reactive extrusion process. New alternative manufacturing methods include adding the lubricants after the addition of the curative system so to not interfere with the curing of the elastomer, by adding in a second pass of the DVA material through the mixer wherein the lubricants are added during the second pass of the DVA, or alternatively by mixing the lube with the DVA finished product pellets before introducing the DVA in a melt extruder prior to blowing or casting DVA film.

To determine the effects of the additives on the filmability of the DVA, samples of the DVA were extruded into a film. The compositions of the DVA and the film characteristics are set forth below.

When possible, standard ASTM tests were used to determine the DVA physical properties (see Table 2). Stress/strain properties (tensile strength, elongation at break, modulus values, energy to break) were measured at room temperature using an Instron™ 4204. Tensile measurements were done at ambient temperature on specimens (dog-bone shaped) width of 0.16 inches (0.41 cm) and a length of 0.75 inches (1.91 cm) length (between two tabs) were used. The thickness of the specimens varied and was measured manually by A Mahr Federal Inc. thickness gauge. The specimens were pulled at a crosshead speed of 20 inches/min. (51 cm/min.) and the stress/strain data was recorded. Test methods are summarized in Table 3.

Oxygen permeability was measured using a MOCON OxTran Model 2/61 operating under the principal of dynamic measurement of oxygen transport through a thin film. The units of measure are cc-mil/m2-day-mmHg and the value obtained may be alternatively referred to as the permeability or impermeability coefficient. Generally, the method is as follows: flat film is clamped into diffusion cells of the MOCON measuring unit; the diffusion cells are purged of residual oxygen using an oxygen free carrier gas. The carrier gas is routed to a sensor until a stable zero value is established. Pure oxygen or air is then introduced into the outside of the chamber of the diffusion cells. The oxygen diffusing through the film to the inside chamber is conveyed to a sensor which measures the oxygen diffusion rate.

Weight gain was determined based on ASTM D-471, by placing a measured sample in an ASTM reference liquid for 72 hours at 120° C. and measuring the change in mass. Higher weight gain values indicate a lower cure level for the material.

TABLE 3

| Parameter | Units | Test |
|---|---|---|
| Modulus | Mpa | ASTM D412 |
| Elongation at Break | % | ASTM D412 |
| MOCON (at 60° C.) | cc-mm/m²-day-mmHg | |

The components used in the samples are identified in Table 4 below.

TABLE 4

| | | Commercial |
|---|---|---|
| Component | Brief Description | Source |
| BIMSM | Brominated para-methylstyrene- | |
| | isobutylene copolymer, 5 wt % PMS, | |
| | 0.75 mol % BrPMS, Mooney viscosity, | |
| | ML (1 + 8) 125° C. = 45 ± 5 | |
| Polyamide | Nylon 6/66, see Table 1 for properties | UBE 5024, |
| copolymer | | from UBE |
| | | Chemical |
| Polyamide | Nylon 6, see Table 1 for properties | Ultramid B27 |
| homopolymer | | |
| PIBSA | Polyisobutylene succinic anhydride, | Dovermulse |
| | MW before anhydride reaction = 950, | H1000 from |
| | viscosity at 100° C. = 459 cSt, | Dover |
| | saponification # = 100 mg KOH/gm | Chemical Corp. |
| Stabilizers | 0.129 phr Tinuvin 622LD | |
| | 0.322 phr Irganox 1098 | |
| | 0.032 phr CuI | |
| Talc | Zinc oxide | Ultratalc 609 |
| Curative | | (multiple |
| | | sources) |
| Lubricant 1 | Stearic acid | |
| Lubricant 2 | Calcium stearate | |

The comparative DVA was prepared in a twin screw extruder mixer. Exemplary DVA were also prepared in a twin screw extruder wherein the additional lubricant components were added after the curative. The DVA materials were then blown into film via conventional bubble film blowing techniques and also extruded into sheets. The blown film and extruded sheets were analyzed. The test results are set forth below in the following table.

TABLE 5

| | A | B | C | D | E | F | G | H |
|---|---|---|---|---|---|---|---|---|
| All parts are in | | | | | | | | |
| phr | | | | | | | | |
| BIMSM | 100.0 | 100.0 | 100.0 | 100.0 | 100.0 | 100.0 | 100.0 | 100.0 |
| Talc | 2.5 | 2.5 | 2.5 | 2.5 | 2.5 | 2.5 | 2.5 | 2.5 |
| Polyamide | 56 | 56 | 56 | 56 | 56 | 56 | 56 | 56 |
| copolymer | | | | | | | | |
| Polyamide | 14 | 14 | 14 | 14 | 14 | 14 | 14 | 14 |
| homopolymer | | | | | | | | |
| PIBSA | 10 | 10 | 10 | 10 | 10 | 10 | 10 | 10 |
| Stabilizer | 0.483 | 0.483 | 0.483 | 0.483 | 0.483 | 0.483 | 0.483 | 0.483 |
| Package (see | | | | | | | | |
| prior Table) | | | | | | | | |
| Zinc Oxide | 3 | 3 | 3 | 3 | 3 | 6 | 6 | 6 |
| Stearate Acid | — | 0.25 | 0.5 | 1.0 | 1.25 | 1.0 | 1.25 | 1.5 |
| Calcium Stearate | — | 0.5 | 1.0 | 2.0 | 2.5 | 2.0 | 2.5 | 3 |
| Test Results | | | | | | | | |
| Blown Film Gel | Severe | Severe | Light | Light | Very | Few | Few | Very |
| Level | gel, | gel | pattern | pattern | few gels | small | small | few |
| | holes in | | of gel | of gel | | clusters | gels | gels |
| | film | | | | | | | |
| Film | 1 | 1 | 2 | 2 | 3 | 3 | 3 | 3 |
| acceptability* | | | | | | | | |
| 10% modulus, | n/a | n/a | 7.5 | 6.2 | 5.2 | 6.6 | 6.3 | 5.5 |
| MPa | | | | | | | | |
| Elongation at | n/a | n/a | 252.1 | 271.6 | 217.8 | 307.0 | 270.7 | 206.4 |
| Break, % | | | | | | | | |
| Extruded sheet | 52 | 51 | 53 | 57 | 67 | 59 | 65 | 71 |
| Weight Gain % | | | | | | | | |
| Extruded sheet | 0.202 | 0.209 | 0.226 | 0.301 | 0.315 | 0.287 | 0.299 | 0.372 |
| MOCON at 60° C. | | | | | | | | |

*1—not acceptable/2—acceptable with minor blemishes/3—good film

The weight gain of the DVA material increases with the addition of the lubricant packages, indicating a reduction in cure level; however, this reduction in cure does not result in more gel in the blown film. With the addition of the lubricant package to the DVA composition, there is a slight increase in the MOCON values as the amount of lubricant components is increased. The MOCON values are still below the desired values of not more than 0.50 cc-mm/m²-day-mmHg, or preferably not more than 0.40 cc-mm/m²-day-mmHg The MOCON permeability coefficient, measured at 60° C., is preferably in the range of 0.40 to 0.20. As evident from the data above, the compositions of the present invention have a very low permeability coefficient, well within the desired range for an air barrier material.

The invention, accordingly, provides the following embodiments:
A. A dynamically vulcanized alloy comprising at least one isobutylene-based elastomer; at least one thermoplastic resin, a cure system, and a lubricant system comprising a metal organic salt and a fatty acid wherein the phr ratio of the metal organic acid salt to the fatty acid is 0.75:1 to 10:1, wherein the elastomer is present as a dispersed phase of small highly vulcanized or partially vulcanized particles in a continuous phase of the thermoplastic resin;
B. The alloy of embodiment A wherein the phr ratio of the metal organic acid salt to the fatty acid is 1:1 to 10:1, or 1:1 to 4:1 or 1.5:1 to 4:1;
C. The alloy of embodiment A or B wherein the lubricant system is present in an amount of 0.75 to 9.0 phr or 0.75 to 6 or 0.75 to 4 or 1.0 to 6 or 1.25 to 4;
D. The alloy of any preceding embodiment A to C or any combination thereof, wherein the phr ratio of the cure system to the lubricant system is in the range of 2:1 to 6:1;
E. The alloy of any preceding embodiment A to D or any combination thereof, wherein the metal organic salt is a metal stearate;
F. The alloy of any preceding embodiment A to E or any combination thereof, wherein the fatty acid is a saturated fatty acid having a carbon number in the range of 10 to 26 or 12 to 24 or 16 to 24;
G. The alloy of any preceding embodiment A to F or any combination thereof, wherein the cure system consists essentially of 0.5 to 10 phr, or 1.0 to 10 phr, or 2 to 8 phr, or 3 to 8 phr of a metal oxide selected from the group consisting of zinc oxide, nanozinc oxide, CaO, BaO, MgO, Al₂O₃, CrO₃, FeO, Fe₂O₃, and NiO;
H. The alloy of any preceding embodiment A to G or any combination thereof, wherein the alloy comprises 2 to 30 phr or 5 to 20 phr or 8 to 15 phr of a compatiblizer, based on the amount of the isobutylene-based elastomer in the alloy;
I. The alloy of any preceding embodiment A to H or any combination thereof, wherein the compatibilizer is an anhydride functionalized oligomer, the oligomer being derived from an alkyl, an aryl, or an alkenyl monomer and having a molecular weight, prior to functionalization, in the range of 500 to 1500;
J. The alloy of any preceding embodiment A to I or any combination thereof, wherein the at least one thermoplastic resin is a mixture of at least two thermoplastic resins wherein the mixture has a relative viscosity of in the range of 3.9 to 2.9;
K. The alloy of any preceding embodiment A to J or any combination thereof, wherein said elastomer is a halogenated isobutylene-isoprene polymer or a halogenated isobutylene-isoprene-alkylstyrene terpolymer or a halogenated isobutylene-alkylstyrene copolymer or a halogenated star-branched isoutylene-isoprene-diene polymer;
L. The alloy of any preceding embodiment A to K or any combination thereof, wherein the elastomer comprises 0.5 to 2.0 mol % of a halogen;
M. The alloy of any preceding embodiment A to L or any combination thereof, wherein wherein the elastomer is a halogenated polymer of isobutylene and paramethylstyrene derived units, wherein the polymer comprises 7 to 12 wt % of the paramethylstyrene derived units;
N. The alloy of any preceding embodiment A to M or any combination thereof, wherein the elastomer is present in the alloy in an amount in the range of 55 to 90 weight percent;
O. The alloy of any preceding embodiment A to N or any combination thereof, wherein the thermoplastic resin is selected from the group consisting of polyamides, polyimides, polycarbonates, polyesters, polysulfones, polylactones, polyacetals, acrylonitrile-butadiene-styrene resins, polyphenyleneoxide, polyphenylene sulfide, polystyrene, styrene-acrylonitrile resins, styrene maleic anhydride resins, aromatic polyketones, ethylene vinyl acetates, ethylene vinyl alcohols, and mixtures thereof;
P. A film formed from an alloy in accordance with any one or any combination of the preceding embodiments A to O;
Q. A method of forming a dynamically vulcanized alloy by combining in a mixer at least one isobutylene based elastomer, at least one thermoplastic resin, a compatibilizer, a cure system, and a lubricant system consisting of a metal organic salt and a fatty acid wherein the phr ratio of the metal organic salt to the fatty acid is 0.75:1 to 10:1, and wherein the lubricant system is added to mixer after the cure system has been introduced into the mixer and after curing of the elastomer has begun;
R. The method of embodiment Q, wherein the components used to form the dynamically vulcanized alloy are selected from any one or any combination of embodiments A to O above.

The invention also provides the following embodiments:
i. A dynamically vulcanized alloy obtained by combining at least one isobutylene based elastomer, a mixture of thermoplastic resins, a compatibilizer, a cure system, and a lubricant system consisting of a metal organic salt and a fatty acid wherein the phr ratio of the metal organic salt to the fatty acid is 0.75:1 to 10:1, and wherein the elastomer is present in the alloy as a dispersed phase of small highly vulcanized or partially vulcanized particles in a continuous phase of the thermoplastic resin; or
ii. A dynamically vulcanized alloy obtained by combining at least one isobutylene based elastomer, a thermoplastic resin, a compatibilizer, a cure system, and a lubricant system consisting of 0.5 to 3 phr of a metal organic salt and 0.25 to 1.5 phr a fatty acid wherein the phr ratio of the metal organic salt to the fatty acid is at least equal to 1.0, and wherein the elastomer is present in the alloy as a dispersed phase of small highly vulcanized or partially vulcanized particles in a continuous phase of the thermoplastic resin.

The inventive compositions can be used to make any number of articles. In one embodiment, the article is selected from tire curing bladders, tire innerliners, tire innertubes, and air sleeves. In another embodiment, the article is a hose or a hose component in multilayer hoses, such as those that contain polyamide as one of the component layers.

1. A dynamically vulcanized alloy comprising:
a) at least one isobutylene-based elastomer;
b) at least one thermoplastic resin;
d) a cure system; and
e) a lubricant system comprising a metal organic salt and a fatty acid wherein the phr ratio of the metal organic acid salt to the fatty acid is 0.75:1 to 10:1,
wherein the elastomer is present in the dynamically vulcanized alloy as a dispersed phase of small vulcanized or partially vulcanized particles in a continuous phase of the thermoplastic resin.

2. The alloy of claim 1, wherein the lubricant system is present in an amount of 0.75 to 9.0 phr.

3. The alloy of claim 1, wherein the phr ratio of the cure system to the lubricant system is in the range of 2:1 to 6:1.

4. The alloy of claim 1, wherein the metal organic salt is a metal stearate.

5. The alloy of claim 1, wherein the fatty acid is a saturated fatty acid having a carbon number in the range of 10 to 26.

6. The alloy of claim 1, wherein the cure system consists essentially of 1.0 to 10 phr of a metal oxide selected from the group consisting of zinc oxide, nanozinc oxide, CaO, BaO, MgO, Al₂O₃, CrO₃, FeO, Fe₂O₃, and NiO.

7. The alloy of claim 1, wherein the alloy comprises 2 to 30 phr of a functionalized oligomer, based on the amount of the isobutylene-based elastomer in the alloy.

8. The alloy of claim 1, wherein the at least one thermoplastic resin is a mixture of at least two thermoplastic resins wherein the mixture has a relative viscosity of in the range of 3.9 to 2.9.

9. The alloy of claim 1, wherein the elastomer is an isobutylene-isoprene derived polymer or an isobutylene-alkylstyrene derived polymer or an isobutylene-isoprene-alklystyrene derived polymer.

10. The alloy of claim 1, wherein the elastomer is present in the alloy in an amount in the range of 55 to 90 weight percent.

11. The alloy of claim 1, wherein the thermoplastic resin is selected from the group consisting of polyamides, polyimides, polycarbonates, polyesters, polysulfones, polylactones, polyacetals, acrylonitrile-butadiene-styrene resins, polyphenyleneoxide, polyphenylene sulfide, polystyrene, styrene-acrylonitrile resins, styrene maleic anhydride resins, aromatic polyketones, ethylene vinyl acetates, ethylene vinyl alcohols, and mixtures thereof.

12. The alloy of claim 1, wherein the dynamically vulcanized alloy is formed into a blown film or extruded cast sheet.

13. A film of dynamically vulcanized alloy, the dynamically vulcanized alloy obtained by combining:
a. at least one C₄ to C₇ isoolefin monomer based elastomer,
b. a mixture of thermoplastic resins,
c. a compatibilizer,
d. a cure system, and
e. a lubricant system consisting of a metal organic salt and a fatty acid wherein the phr ratio of the metal organic salt to the fatty acid is 0.75:1 to 10:1,
and wherein the elastomer is present in the dynamically vulcanized alloy as a dispersed phase of small highly vulcanized or partially vulcanized particles in a continuous phase of the thermoplastic resin.

14. The film of claim 13, wherein the compatibilizer is an anhydride functionalized oligomer, the oligomer being derived from an alkyl, an aryl, or an alkenyl monomer and having a molecular weight, prior to functionalization, in the range of 500 to 1500.

15. The film of claim 14, wherein the anhydride functionalized oligomer is a poly-n-alkyl succinic anhydride or a poly-iso-alkyl succcinic anhydride.

16. A method of forming a dynamically vulcanized alloy, the method comprising the steps of:
a. combining in a mixer at least one isobutylene based elastomer, at least one thermoplastic resin, and a cure system,
b. mixing the elastomer, thermoplastic resin, and cure system at a temperature at or above the cure temperature of the elastomer,
c. after the curing of the elastomer has begun, adding into the mixer a lubricant system consisting of a metal organic salt and a fatty acid wherein the phr ratio of the metal organic salt to the fatty acid is 0.75:1 to 10:1, and
d. continuing the mixing until the elastomer is dispersed as discrete particles in a continuous matrix of the thermoplastic resin forming a dynamically vulcanized alloy.

17. The method of forming a dynamically vulcanized alloy as set forth in claim 16, wherein a compatibilizer is added to the mixer in step a.

18. The method of forming a dynamically vulcanized alloy as set forth in claim 16, wherein in step a, the isobutylene based elastomer and the at least one thermoplastic resin are first combined in the mixer without the cure system and are mixed together at a temperature to melt the at least one thermoplastic resin.
